(19) United States
(12) Patent Application Publication
(10) Pub. No.: US 2011/0270773 A1
(43) Pub. Date: Nov. 3, 2011

(54) HOME MAINTENANCE RECOMMENDATION TOOL

(75) Inventors: James Siekman, Charlotte, NC (US); Elizabeth S. Votaw, Potomac, MD (US); Marc Mathies, Newbury Park, CA (US)

(73) Assignee: BANK OF AMERICA CORPORATION, Charlotte, NC (US)

(21) Appl. No.: 12/771,694

(22) Filed: Apr. 30, 2010

(51) Int. Cl. G06Q 10/00

(52) U.S. Cl. 705/305

(57) ABSTRACT

Embodiments of the present invention provide a home maintenance recommendation tool that is incorporated into a user's online financial account. The home maintenance recommendation tool, generally provides a user the ability to review, edit, submit, and track home maintenance repairs needed on the one or more properties owned by the user. The home maintenance recommendation tool receives information related to repairs that the property might need through information that is captured when the mortgage is originated, purchased, or serviced, or through purchases made by the user at a business using certain financial accounts. The home maintenance recommendation tool also provides the user the ability to search, identify, receive, and purchase products and services needed to make the suggested repairs through businesses that are strategic partners with the financial institution using the user's online financial account.

### FIELD

Embodiments of this invention relate generally to apparatuses and methods for an online mortgage center that assists customers with maintaining and increasing the value of homes owned by the customers.

### BACKGROUND

Purchasing a house, condominium, condominium complex, apartment, apartment complex, townhouse, other residential building, commercial building, or other type of property (hereinafter “property”) is a major investment for any individual or business. Individuals or businesses may purchase such a property for personal enjoyment, as an investment, for business purposes, etc., but regardless of the reason, the property is often one of the most expensive, if not the most expensive, asset that an individual or business owns. In order to make a purchase on a piece of property an individual or business often asks a bank or other financial institution to finance the transaction. Before the bank makes a determination as to whether or not to extend the individual or business the funds necessary to purchase the property, the bank often, if not always, performs an extensive investigation into the property and the finances of the individual or business. The bank may have an appraiser, inside or outside the bank, determine the market value of the property. The bank may have environmental, structural, economic, etc. appraisers evaluate the property before determining if the purchase price meets the market value of the property. The bank often, if not always, performs an analysis of the finances of the individual or business, including the assets, such as but not limited to cash, other properties, investments, equipment, inventory, accounts receivable, active income, passive income, etc., and debt, such as but not limited to property loans, student loans, credit card balances, accounts payable, expenses, etc. The bank then makes a determination on whether or not to lend the individual or business the money to purchase the property, and, if they decide to lend, how much the bank is willing to lend the individual or business.

As much as the property is an investment for the individual or business, the loan is an investment for the bank, which is often secured by the property itself. Therefore, the bank has a conditional vesting interest in the property, and thus in the condition of the property over the life of the loan. The interest in the property only vests if the individual or business defaults on the loan, and the bank is forced to foreclose on the property in order to try to recoup at least the remaining balance on the loan (or any amount above the remaining balance on the loan).

For all of the time and effort in determining the market value of the property and the financial ability of the individual or business to pay for the property, very little, if anything, is done by the bank after the transaction is completed to determine that the individual or business is maintaining, or in some cases increasing, the value of the property. Maintaining or increasing the value of the property has become an increasing point of interest for banks The more the property is worth, the more the bank can get for the property if and when the bank's interest in the property vests. The value of the property becomes increasingly important in times of economic instability where individuals are being laid off and businesses are losing customers, which results in an overall reduction in disposable income. As a result, the number of foreclosures increase and the value of properties decrease because of a reduction in demand. When the prices of homes fall, the homes are often worth less than what the owners paid for the homes, or what the owners owe on the mortgage. Therefore, it is increasingly important for the bank to make sure the value of the property is as high as it can be, in case the owner defaults on the loan and the bank is forced to foreclose and sell the property to recover the balance of the loan. Thus, there is a need to develop apparatuses and methods to help individuals or businesses, either directly or indirectly, to maintain or improve the value of their property.

### BRIEF SUMMARY

Embodiments of the present invention address the above needs and/or achieve other advantages by providing apparatuses (e.g., a system, computer program product, and/or other device) and methods that provide a home maintenance recommendation tool that, in one embodiment, is incorporated into a user's online banking account. The following presents a simplified summary of several embodiments of the invention in order to provide a basic understanding of such embodiments. This summary is not an extensive overview of all contemplated embodiments of the invention, and is intended to neither identify key or critical elements of all embodiments, nor delineate the scope of any or all embodiments. Its purpose is to present some concepts of one or more embodiments in a simplified form as a prelude to the more detailed description that is presented later.

Generally, embodiments of the home maintenance recommendation tool provide a user the ability to review, edit, submit, and track home maintenance repairs needed on the one or more properties owned by the user. The home maintenance recommendation tool receives information related to repairs that the property might need through information that is captured when the mortgage is originated or purchased, or through purchases made by the user at particular businesses using accounts inside and outside of the user's bank that holds the mortgages on the property. The home maintenance recommendation tool also provides the user the ability to search, identify, receive, and purchase goods and services (hereinafter “products”) needed to make the suggested repairs offered by businesses that are strategic partners with the bank, using the user's online banking account.

One embodiment of the invention is a home maintenance recommendation system comprising, a memory device, a communication device, and a processing device operatively coupled to the memory device and the communication device. The processing device is configured to execute computer-readable program code to receive home maintenance metrics for a property. The processing device is further configured to determine a maintenance action that a user should perform on the property, based at least in part on the home maintenance metrics. The processing device is further configured to display a maintenance action list reporting the maintenance action that the user should perform on the property in a home maintenance interface.

In further accord with an embodiment of the invention, the home maintenance metrics received are received from a mortgage origination, a mortgage purchase, or a mortgage refinance. In another embodiment of the invention, the home maintenance metrics received are received from a purchase the user made.

In yet another embodiment of the invention, the processing device is further configured to receive mortgage information for the property for setting up a mortgage account in an online banking application that allows the user to access the home maintenance interface.

In still another embodiment of the invention, the processing device is further configured to generate a product list of one or more products for the maintenance action and display the product list of one or more products for the maintenance action to the user.

In further accord with an embodiment of the invention, the processing device is further configured to prompt the user to purchase one or more products for the maintenance action. In another embodiment of the invention, the processing device is further configured to prompt the user to have the one or more products for the maintenance action shipped. In yet another embodiment of the invention, the processing device is further configured to prompt the user to pick-up the one or more products for the maintenance action from a store location.

In still another embodiment of the invention, the processing device is further configured to prompt the user to view a product list of one or more products for the maintenance action to purchase at a store location.

In another embodiment of the invention, the processing device is further configured to receive an authentication request from the user to access the home maintenance recommendation system.

In yet another embodiment of the invention, the processing device is further configured to receive information related to one or more maintenance actions that the user wants to add to the maintenance action list.

In still another embodiment of the invention, the processing device is further configured to receive information related to one or more products that the user wants to add to the maintenance action.

In further accord with an embodiment of the invention, the processing device is further configured to receive information related to a disposition that the user assigns to the maintenance action.

In another embodiment of the invention, the mortgage information comprises an amount of the mortgage, a mortgage payment schedule, or a mortgage account number.

In yet another embodiment of the invention, the home maintenance metrics comprise a home address, size of home, acreage of land, number of rooms, number of bathrooms, flooring type, age of home, date of any major work done on home, the roof type, roof age, furnace type, furnace age, water heater type, water heater age, air conditioner type, air conditioner age, dishwasher type, dishwasher age, fridge types, fridge age, stove type, stove age, siding type, siding age, sewer system type, or sewer system age.

One embodiment of the invention is a home maintenance recommendation method comprising receiving home maintenance metrics for a property. The method further comprises determining, through the use of a processor, a maintenance action that the user should perform on the property, based at least in part on the home maintenance metrics. The method also comprises displaying a maintenance action list reporting the maintenance action that the user should perform on the property in a home maintenance interface.

In further accord with an embodiment of the invention, receiving home maintenance metrics comprises receiving home maintenance metrics from a mortgage origination, a mortgage purchase, or a mortgage refinance. In another embodiment of the invention, receiving home maintenance metrics comprises receiving home maintenance metrics from a purchase the user made.

In yet another embodiment of the invention, the method also comprises receiving mortgage information for the property for setting up a mortgage account in an online banking application that allows the user to access the home maintenance interface.

In still another embodiment of the invention, the method further comprises generating, through the use of the processor, a product list of one or more products for the maintenance action and displaying the product list of one or more products for the maintenance action to the user.

In another embodiment of the invention, the method further comprises prompting, through the use of the processor, the user to purchase one or more of the products for the maintenance action. In yet another embodiment of the invention, the method further comprises prompting, through the use of the processor, the user to have the one or more products for the maintenance action shipped. In still another embodiment of the invention, the method further comprises prompting, through the use of the processor, the user to pick-up the one or more products for the maintenance action from a store location.

In further accord with an embodiment of the invention, the method further comprises prompting, through the use of the processor, the user to view a product list of one or more products for the maintenance action to purchase at a store location.

In another embodiment of the invention, the method further comprises receiving, through the use of the processor, an authentication request from the user to access the home maintenance interface.

In still another embodiment of the invention, the method further comprises receiving, through the use of the processor, information related to one or more maintenance actions that the user wants to add to the maintenance action list.

In further accord with an embodiment of the invention, the method further comprises receiving, through the use of the processor, information related to adding one or more products that the user wants to add to the maintenance action.

In another embodiment of the invention, the method further comprises receiving, through the use of the processor, information related to a disposition that the user assigns to the maintenance action.

In yet another embodiment of the invention, the mortgage information comprises an amount of the mortgage, a mortgage payment schedule, or a mortgage account number.

In still another embodiment of the invention, the home maintenance metrics comprise a home address, size of home, acreage of land, number of rooms, number of bathrooms, flooring type, age of home, date of any major work done on home, the roof type, roof age, furnace type, furnace age, water heater type, water heater age, air conditioner type, air conditioner age, dishwasher type, dishwasher age, fridge types, fridge age, stove type, stove age, siding type, siding age, sewer system type, or sewer system age.

One embodiment of the invention is a computer program product for a home maintenance recommendation system, the computer program product comprises at least one non-transitory computer-readable medium having computer-readable program code portions embodied therein. The computer-readable program code portions comprise an executable portion configured for receiving home maintenance metrics for a property. The computer-readable program code portions further comprise an executable portion configured for determining a maintenance action that the user should perform on the property, based at least in part on the home maintenance metrics. The computer-readable program code portions further comprise an executable portion configured for displaying a maintenance action list reporting the maintenance action that the user should perform on the property in a home maintenance interface.

In further accord with an embodiment of the invention, the executable portion configured for receiving home maintenance metrics comprises an executable portion configured for receiving home maintenance metrics from a mortgage origination, a mortgage purchase, or a mortgage refinance. In another embodiment of the invention, the executable portion configured for receiving home maintenance metrics comprises an executable portion configured for receiving home maintenance metrics from a purchase the user made.

In yet another embodiment of the invention, the computer program product further comprises an excludable portion configured for receiving mortgage information for the property for setting up a mortgage account in an online banking application that allows the user to access the home maintenance interface.

In still another embodiment of the invention, the computer program product further comprises an executable portion configured for generating a product list of one or more products for the maintenance action and an executable portion configured for displaying the product list of one or more products for the maintenance action to the user.

In further accord with an embodiment of the invention, the computer program product further comprises an executable portion configured for prompting the user to purchase one or more of the products for the maintenance action. In another embodiment of the invention, the computer program product further comprises an executable portion configured for prompting the user to have the one or more products for the maintenance action shipped. In yet another embodiment of the invention the computer program product further comprises an executable portion configured for prompting the user to pick-up the one or more products for the maintenance action from a store location.

In another embodiment of the invention, the computer program product further comprises an executable portion configured for prompting the user to view a product list of one or more products for the maintenance action to purchase at store location.

In yet another embodiment of the invention, the computer program product further comprises an executable portion configured for receiving an authentication request from the user to access the home maintenance interface.

In still another embodiment of the invention, the computer program product further comprises an executable portion configured for receiving information related to one or more maintenance actions that the user wants to add to the maintenance action list.

In further accord with an embodiment of the invention, the computer program product further comprises an executable portion configured for receiving information related to adding one or more products that the user wants to add to the maintenance action.

In another embodiment of the invention, the computer program product further comprises an executable portion configured for receiving information related to a disposition that the user assigns to the maintenance action.

In yet another embodiment of the invention, the mortgage information comprises an amount of the mortgage, a mortgage payment schedule, or a mortgage account number, through the use of the processing device.

In still another embodiment of the invention, the home maintenance metrics comprise a home address, size of home, acreage of land, number of rooms, number of bathrooms, flooring type, age of home, date of any major work done on home, the roof type, roof age, furnace type, furnace age, water heater type, water heater age, air conditioner type, air conditioner age, dishwasher type, dishwasher age, fridge types, fridge age, stove type, stove age, siding type, siding age, sewer system type, or sewer system age.

On embodiment of the invention is an online banking home maintenance recommendation system comprising a memory device, a communication device, and a processing device operatively coupled to the memory device and the communication device. The processing device is configured to execute computer-readable program code to receive home maintenance metrics for a property in an online banking application. The processing device is further configured to determine a maintenance action that a user should perform on the property, based at least in part on the home maintenance metrics. The processing device is further configured to display a maintenance action list reporting the maintenance action that the user should perform on the property in a home maintenance interface in the online banking application.

In further accord with an embodiment of the invention, the home maintenance metrics received are received from a mortgage origination, a mortgage purchase, a mortgage refinance, or from a from a purchase the user made.

One embodiment of the invention is an online banking home maintenance recommendation method that comprises receiving home maintenance metrics for a property in an online banking application. The method further comprises determining, through the use of a processor, a maintenance action that the user should perform on the property, based at least in part on the home maintenance metrics. The method also comprises displaying a maintenance action list reporting the maintenance action that the user should perform on the property in a home maintenance interface in the online banking application.

In further accord with an embodiment of the invention, receiving home maintenance metrics comprises receiving home maintenance metrics from a mortgage origination, a mortgage purchase, a mortgage refinance, or from a purchase the user made.

The features, functions, and advantages that have been discussed may be achieved independently in various embodiments of the present invention or may be combined in yet other embodiments, further details of which can be seen with reference to the following description and drawings.

### BRIEF DESCRIPTION OF THE SEVERAL VIEWS OF THE DRAWINGS

Having thus described embodiments of the invention in general terms, reference will now be made to the accompanying drawings, wherein:

FIG. 1 provides a block diagram illustrating a home maintenance recommendation system and environment, in accordance with an embodiment of the present invention;

FIG. 2 provides a process map illustrating a home maintenance recommendation process, in accordance with one embodiment of the present invention;

FIG. 3 provides an online banking interface for setting up a home maintenance recommendation program, in accordance with one embodiment of the present invention;

FIG. 4 provides a home maintenance recommendation account interface, in accordance with one embodiment of the present invention;

FIG. 5 provides a home maintenance recommendation project entry interface, in accordance with one embodiment of the present invention;

FIG. 6 provides a home maintenance recommendation project list interface, in accordance with one embodiment of the present invention; and

FIG. 7 provides a home maintenance recommendation shopping interface, in accordance with one embodiment of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout. Although some embodiments of the invention described herein are generally described as involving a “bank,” one of ordinary skill in the art will appreciate that other embodiments of the invention may involve other businesses or financial institutions that take the place of or work in conjunction with the bank to perform one or more of the processes or steps described herein as being performed by a bank.

As will be appreciated by one of ordinary skill in the art in view of this disclosure, the present invention may be embodied as an apparatus (including, for example, a system, machine, device, computer program product, and/or the like), as a method (including, for example, a business process, computer-implemented process, and/or the like), or as any combination of the foregoing. Accordingly, embodiments of the present invention may take the form of an entirely software embodiment (including firmware, resident software, micro-code, etc.), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out operations of the present invention may include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, etc.) that can direct a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator- and/or human-implemented steps in order to carry out an embodiment of the present invention.

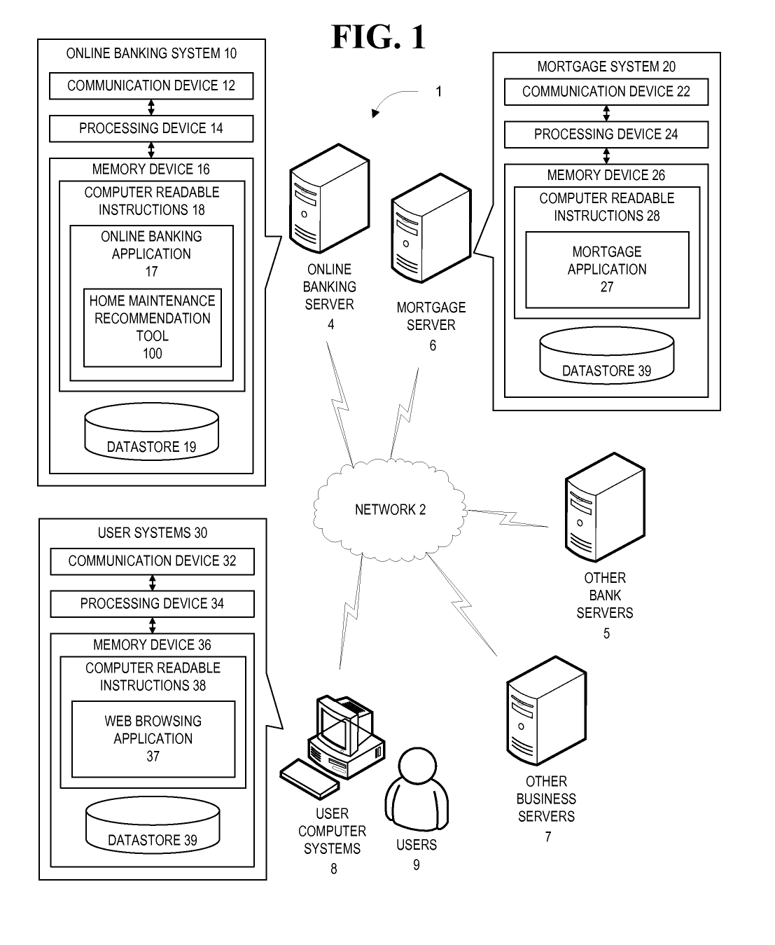

FIG. 1 illustrates a home maintenance recommendation system and environment 1, in accordance with an embodiment of the present invention. As illustrated in FIG. 1, the online banking server 4 is operatively coupled, via a network 2 to the mortgage server 6, other bank servers 5, other business servers 7, and the user computer systems 8. In this way, the online banking system 10 can receive and send information from and to the mortgage system 20, user system 30, and systems located on other bank servers 5 and other business servers 7, so users 9 can view the home maintenance repair information through their online banking accounts. In some embodiments of the invention, the users 9 are customers of the bank and hold accounts with the bank, however in other embodiments of the invention the users 9 are employees, agents contractors, people, etc. who do not have accounts at the bank, but are allowed to use the home maintenance repair application 100 on their own or with the approval of a bank customer. The network 2 may be a global area network (GAN), such as the Internet, a wide area network (WAN), a local area network (LAN), or any other type of network or combination of networks. The network 2 may provide for wireline, wireless, or a combination of wireline and wireless communication between devices on the network.

As illustrated in FIG. 1, the online banking system 10 is located on the online banking server 4, and generally comprises a communication device 12, a processing device 14, and a memory device 16. As used herein, the term “processing device” generally includes circuitry used for implementing the communication and/or logic functions of a particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs based on computer-readable instructions thereof, which may be stored in a memory device.

The processing device 14 is operatively coupled to the communication device 12, and the memory device 16. The processing device 14 uses the communication device 12 to communicate with the network 2, and other devices on the network 2, such as, but not limited to, the mortgage server 6, other bank servers 5, other business servers 7, and user computer systems 8. As such, the communication device 12 generally comprises a modem, server, or other device for communicating with other devices on the network 2.

As further illustrated in FIG. 1, the online banking system 10 comprises computer-readable instructions 18 stored in the memory device 16, which in one embodiment include the computer-readable instructions 18 of an online banking application 17 which includes a home maintenance recommendation tool 100. In some embodiments, the memory device 16 includes a datastore 19 for storing data related to the online banking system 10, including but not limited to data created and/or used by the online banking application 17 and the home maintenance recommendation tool 100.

In the embodiment illustrated in FIG. 1 and described throughout much of this specification, the home maintenance recommendation tool 100 is illustrated as a tool that runs inside of and in conjunction with the online banking application 17. It is to be understood that in other embodiments of the invention, the home maintenance recommendation tool 100 is a part of the online banking application 17 itself, or in other embodiments is a separate application outside of the online banking application 17 that works in conjunction with the online banking application 17. In still other embodiments, the home maintenance recommendation tool 100 is operated by a third party system in communication with the online banking server 4 and/or mortgage server 6. Regardless of the configuration of the online banking application 17 and home maintenance recommendation tool 100, it is to be understood that they will work in substantially the same or similar way as they are described herein. Similarly, it will be understood that systems, devices, servers, processors, computers, networks, and other devices described herein may be made up of one system, device, server, processor, computer, network, etc., or numerous systems, devices, servers, processors, computers, networks, etc. working in conjunction with each other.

The home maintenance recommendation tool 100, generally provides a user the ability to review, edit, submit, and track home maintenance repairs needed on the one or more properties owned by the user 9. The home maintenance recommendation tool 100 also provides the user 9 the ability to search, identify, receive, and purchase products through the user's online banking account that relate to home maintenance repairs. The home maintenance recommendation tool 100 receives information though pushing or pulling data from the mortgage server 6, which stores information regarding mortgages originated and/or serviced by the bank, and other bank servers 5, which stores information related to purchases made by the user 9 using accounts at the bank. The home maintenance recommendation tool 100, also receives and sends (through pushing or pulling) information located on other business servers 7, which stores information related to mortgages serviced at other banks and/or purchases made through or at other businesses.

Home maintenance, in many cases, is the most important thing a homeowner can do to protect the value of the homeowner's investment. The home maintenance recommendation tool 100 utilizes the bank's already popular and useful online banking application 17 to provide home maintenance information to users 9. Each maintenance project in the list comprises a list of supplies needed to complete the suggested maintenance project, as well as various vendors that supply the list of products. The user 9 can order the supplies on-line and have them shipped or pick them up at a store location of the strategic partner. Additionally, should the customer not want to fulfill the order on-line, the supply lists can be printed and taken to strategic partners, or other businesses, where the user 9 can purchase the needed items for the home maintenance project. Regardless of the fulfillment channel, the user 9 may receive a discount (e.g. 3%-10% or other percentage) for being a bank customer or for using the home maintenance recommendation tool 100. In some embodiments, the information on the home maintenance interfaces includes, but is not limited to monthly checklists for home maintenance projects. In some cases the checklists are tailored to regional needs, driven by location information such as country, region, state, county, city, zip code, street address, and/or the like. The home maintenance recommendation tool 100 empowers the owner with information to maintain the owner's home and stay on top of the activities in and around it that contribute to the property value of the home, as well as surrounding homes. In some embodiments, the home maintenance recommendation interfaces list “to do” activities that should be accomplished. The list can be separated by day, week, month, three months, etc. in the same or similar way as a computerized calendar.

The home maintenance recommendation tool 100 assists users with maintaining, and possibly increasing, value of the user's house, while simultaneously providing the bank protection against asset value destruction driven by deferred maintenance, providing a revenue stream through promoting cross-selling opportunities with strategic partners, and providing opportunities to demonstrate the commitment to the bank branding of home loans.

As further illustrated in FIG. 1, the mortgage systems 20 are located on the mortgage servers 6. The mortgage systems 20 generally comprise a communication device 22, a processing device 24, and a memory device 26. The processing device 24 is operatively coupled to the communication device 22 and the memory device 26. The processing device 24 uses the communication device 22 to communicate with the network 2, and other devices on the network 2, such as, but not limited to, the online banking server 4, mortgage server 6, other bank servers 5, other business servers 7, and/or user computer systems 8. As such, the communication device 22 generally comprises a modem, server, or other device(s) for communicating with other devices on the network 2.

As illustrated in FIG. 1, the mortgage systems 20 comprise computer-readable program instructions 28 stored in the memory device 26, which in one embodiment includes the computer-readable instructions 28 of a mortgage servicing application 27. In some embodiments, the memory device 26 includes a datastore 29 for storing data related to the mortgage system 20, including but not limited to data created and/or used by the mortgage servicing application 27

The mortgage servicing application 27, in some embodiments captures metrics related to the home address, size of the home, acres of land, number of rooms, number of bathrooms, wood floors/carpeting, the age of the home, the dates of any major work done on the home (i.e. windows replaced, updated kitchen, updated bathroom, expansion of the house), type and age of the roof, furnace, water heater, air conditioner, dishwasher, fridge, stove, siding, sewer system, etc., when the loans are originated by the bank. In other embodiments the mortgage servicing application 27 captures the same or similar information as described with respect to the originating mortgage metrics when the loans are purchased by the bank from other mortgage originators for servicing.

As further illustrated in FIG. 1, the user systems 30 are located on the user computer systems 8. The user systems 30 generally comprise a communication device 32, a processing device 34, and a memory device 36. The processing device 34 is operatively coupled to the communication device 32 and the memory device 36. The processing device 34 uses the communication device 32 to communicate with the network 2, and other devices on the network 2, such as, but not limited to, the online banking server 4, mortgage server 6, other bank servers 5, and/or other business servers 7. As such, the communication device 32 generally comprises a modem, server, or other device(s) for communicating with other devices on the network 2, and a display, camera, keypad, mouse, keyboard, microphone, and/or speakers for communicating with one or more users 9.

As illustrated in FIG. 1, the user systems 30 comprise computer-readable program instructions 38 stored in the memory device 36, which in one embodiment includes the computer-readable instructions 38 of a web browsing application 37. In some embodiments, the memory device 36 includes a datastore 39 for storing data related to the customer system 30, including but not limited to data created and/or used by the web browsing application 37. The web browsing application 37 allows the user 9 to communicate with the online banking application 17 in order to accesses the user's online banking account and/or the home maintenance recommendation tool 100.

The other bank servers 5 and other business servers 7 are operatively coupled to the online banking server 4, mortgage server 6, and the user computer systems 8 through the network 2. The other bank servers 5 and other business servers 7 have systems with devices the same or similar to the devices described for the online banking system 10, mortgage system 20, and customer system 30 (i.e. communication device, processing device, memory device with computer-readable instructions, datastore, etc.). Thus, the other bank servers 5 and other business servers 7 communicate with the online banking system 10, mortgage system 20, and customer system 30 in the same or similar way as previously described with respect to each system. In this way, the users 9 can utilize the user computer systems 8 to allow information such as home mortgage information and metrics, and purchasing information from accounts at the bank and at other financial institutions or business to be incorporated into the user's online banking account for use with the home maintenance recommendation tool 100.

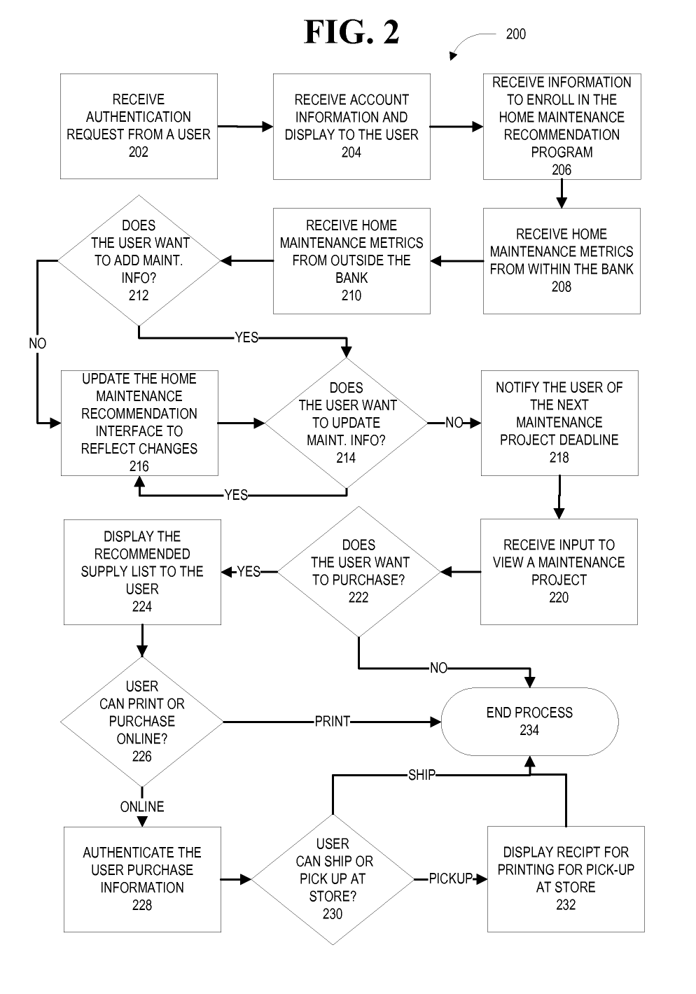

FIG. 2 illustrates a home maintenance recommendation process 200 in accordance with an embodiment of the present invention. As illustrated, in block 202 of FIG. 2, the online banking application 17 receives an authentication request from a user 9 to access the user's online banking application 17, or home maintenance recommendation tool 100. In some embodiments, the user 9 can access the home maintenance recommendation tool 100 within the online banking application 17, if the user 9 has already set up the home maintenance recommendation program. The bank will authenticate the user 9 as the correct account holder for the account that the user 9 is trying to access, and if authenticated, display the user's online banking accounts.

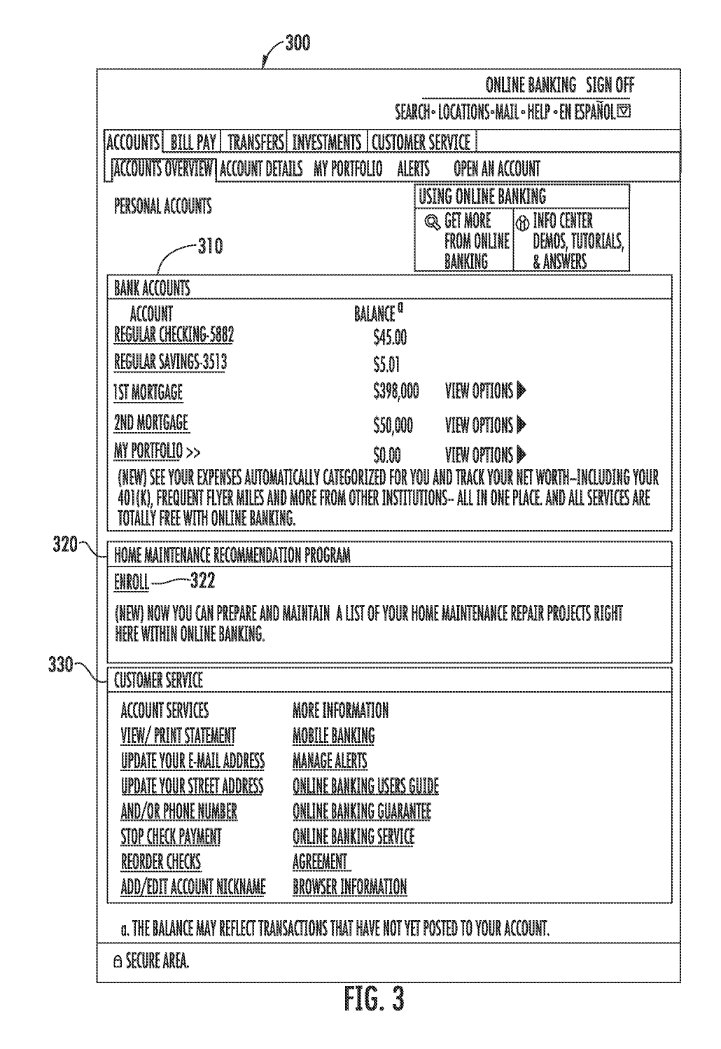

As illustrated in block 204 of FIG. 2, after the user 9 is authenticated, the online banking application 17 will receive account information for the user's online banking accounts and display them to the user 9. For example, the online banking application 17 receives the checking account number and balance, the savings account number and balance, and the first and second mortgage account numbers and balances. In one embodiment of the invention, the online banking application 17 will display information to the user 9 in an account interface 300, as illustrated in FIG. 3. As illustrated in FIG. 3, the user's account information, including his mortgage information, is presented to the user 9 in the banking account interface 300. The banking account interface 300, in some embodiments, provides a bank account section 310, a home maintenance recommendation program section 320, and a customer service section 330.

The mortgage account information can originate from the user 9 opening a mortgage with the bank to purchase a new home, opening a home equity line of credit (HELOC) on the user's home, refinancing, etc., or in other embodiments the mortgage information can originate from a mortgage purchased by the bank for servicing. In either case when the bank originates or services a loan the bank captures the mortgage information, such as but not limited to the amount of mortgage, the payment schedule, etc. and stores the information in the mortgage application 27 on the mortgage systems 20. The online banking application 17 captures the mortgage information from the mortgage application 27 on the mortgage system 20 and populates the mortgage account information in the user's online banking account. The user 9 can select a first mortgage link 312 and a second mortgage link 314 in the bank account section 310 in order to view the account details of the user's first and second mortgage, payments made, payment schedules, etc. In this way the user 9 can access mortgage account information through the user computer systems 8, and manage the user's mortgage account to make mortgage payments, etc. The user 9 can also select the links in the customer service section 330 to view information related to accounts at the bank or receive help with questions regarding products provided by the bank.

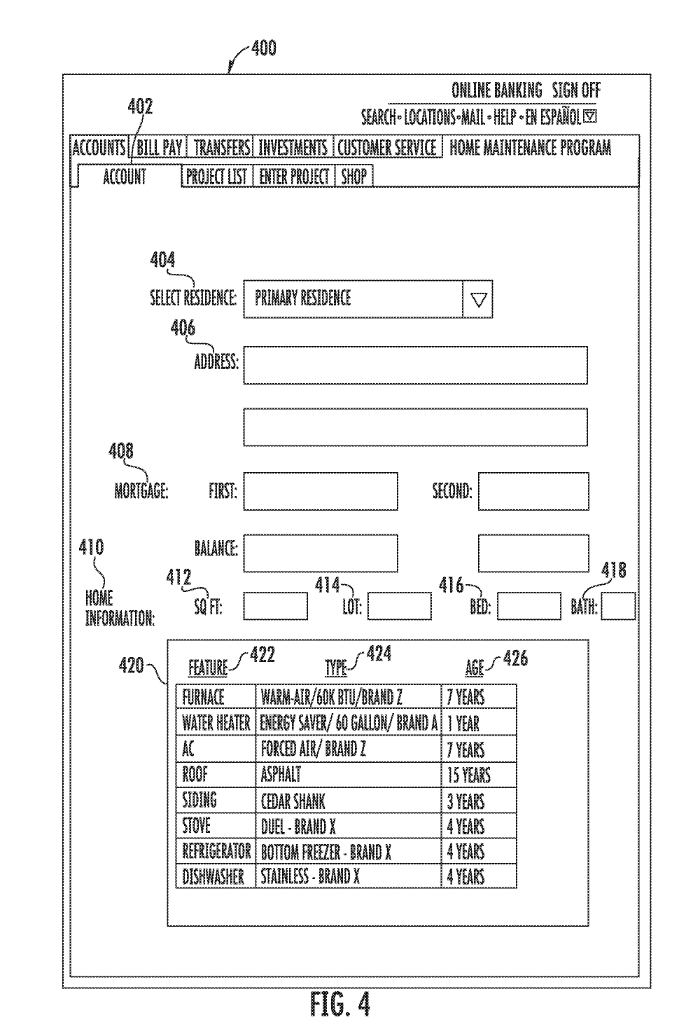

As illustrated by block 206 in FIG. 2, the home maintenance recommendation program section 320, allows the user 9 to set up the home maintenance recommendation program by selecting the enroll link 322. After selecting the enroll link 322, the home maintenance recommendation tool 100 displays to the user 9 the home maintenance recommendation account tab 402 illustrating the home maintenance recommendation account interface 400, as illustrated in FIG. 4. The home maintenance recommendation account interface 400, in some embodiments, comprises a select residence section 404, an address section 406, a mortgage section 408, and a home information section 410. As illustrated by block 204 in FIG. 2, the mortgage information can be populated automatically from the mortgage server 6 when the user 9 decides to enroll in the home maintenance program. In some embodiments of the invention the user 9 can populate the sections himself by entering the residence (primary, second, third, etc. residence), the address of the residence, the mortgages balances, etc.

As illustrated by block 208 in FIG. 2, the home maintenance recommendation tool 100 populates home maintenance metrics from within the bank, through the mortgage server 6 and other bank servers 5. When the mortgage is originated or purchased by the bank, the bank may also capture additional mortgage metrics, such as but not limited to the square footage of the house, the size of the lot, the number of bedrooms, the number of bathrooms, the age and type of the furnace, water heater, air conditioning unit, roof, siding, stove, refrigerator, dishwasher, etc. and stores these metrics in the mortgage application 27 of the mortgage system. For example, these metrics may be obtained from an appraisal, home inspection, mortgage application, insurance application, and/or the like. Furthermore, the bank has vast amounts of transaction data from the user's other accounts at the bank. For example, every time the user 9 makes a transaction for a product using an account maintained by the bank, the transaction is captured by the bank on other bank systems 5, such as bank credit card servers and bank debit card servers. Each of the transactions may include information, such as, the transaction amount, the merchant, the location at which the transaction was made, what products were purchased, and/or what categories of products do the products purchased fall into. For example, if the user 9 made purchases at a restaurant for food the category would be described as dinning, or the like. If the user 9 made purchases at a one stop shopping center, the products would be categorized as food, home goods, and/or home maintenance goods, etc. depending on the type of goods purchased. Additionally, if the user 9 made purchases at a hardware store the products would be categorized as home maintenance products, again in some embodiments, depending on the type of products purchased (i.e. air filters, as opposed to car filters, etc.).

As illustrated by block 210, in some embodiments of the invention the home maintenance application 100 can also populate home maintenance metrics from outside of the bank through the other business servers 7. For example, in some embodiments, the home maintenance recommendation tool 100 can receive information from strategic partners, such as the last time the user 6 purchased paint, roofing materials, energy efficient appliances, etc. In some embodiments, the information is automatically imputed into the home maintenance recommendation interfaces, or in other embodiments the user 9 will be prompted, as to whether the purchases made were related to home maintenance repairs made on the user's home. In other embodiments, the user 9 can allow the home maintenance application 100 to receive information from accounts the user 9 has at other institutions. For example, in some embodiments of the invention the user 9 uses a debit card, credit card, etc. from another bank or business. In these cases, the user 9 can allow the online banking application 17, and specifically the home maintenance recommendation tool 100 to receive, through a data push or pull, maintenance metrics related to transactions made by the user 9 through other businesses, by providing the bank with the log-in and account number of the online accounts the user 9 utilizes to make purchases. In other embodiments of the invention, the user 9 can upload any transactions into the home maintenance recommendation tool 100 himself. As previously, described the information includes the amount paid for products, the products purchased, the categories that each of the products fall into, etc.

As illustrated in the home information section 410 of FIG. 4, the home maintenance metrics that are received by the home maintenance recommendation tool 100, can include but are not limited to the home's square footage 412, lot size 414, number of bedrooms 416, number of bathrooms 418, as well as the information regarding the home in the metric display section 420. The metric display section 420 can include information about a home feature 422, such as but not limited to the furnace, water heater, air conditioner, roof, siding, stove refrigerator, dishwasher, flooring of rooms, painting/wallpaper used in rooms, tile used in rooms, maintenance and repairs done on the garage, lawn care information, etc. The metric display section 420 also includes, in some embodiments, the type 424 of feature, for example the size, name, and producer of the feature 420, as well as the age 426 of the feature or the date the feature was replaced.

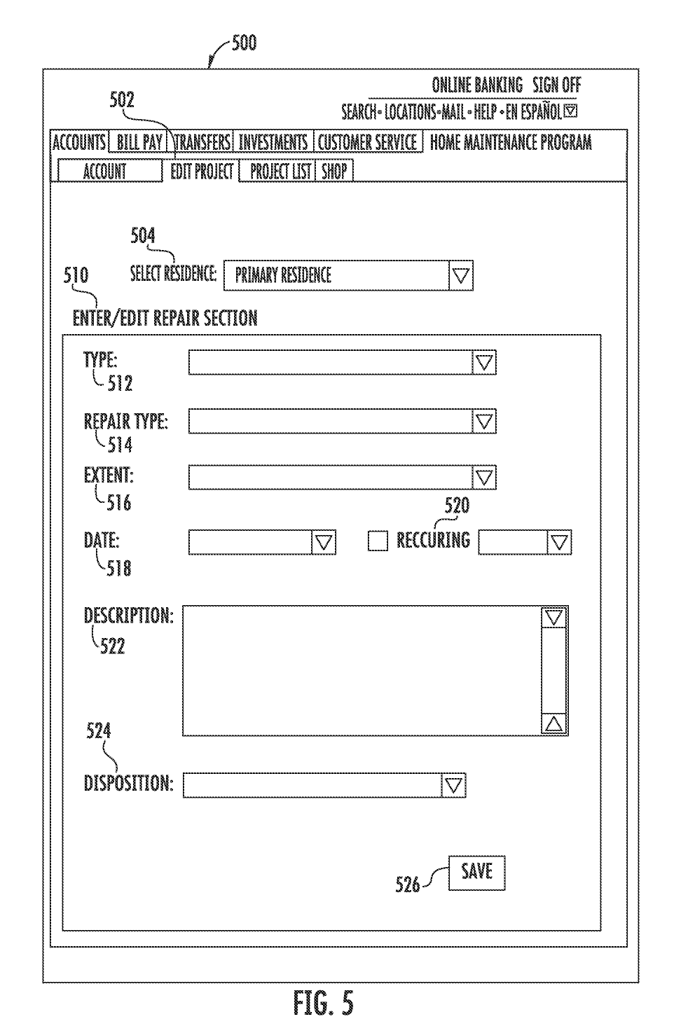

As illustrated by decision block 212 and block 214, the user 9 can add or edit maintenance information in the home maintenance recommendation program. For example, in some embodiments the user 9 can add home maintenance repair information, such as but not limited to a reminder to replace air conditioning filters, a reminder to treat the house for insects, a reminder to treat the yard with weed killer, a maintenance project to service the furnace, water heater, and air conditioning units, a maintenance project to renovate the bathroom, etc. In other embodiments of the invention, the user 9 can indicate that the maintenance project is not started, in process, completed, etc. In one embodiment of the invention, the user 9 can add or edit the maintenance metrics by selecting the edit project tab 502, which displays the edit projects interface 500 illustrated in FIG. 5. In some embodiments of the invention, the edit projects interface 500, has a select residence section 504 and an enter/edit repair project section 510. The enter/edit repair project section 510 includes, but is not limited to, a type selection 512, the repair type selection 514, the extent selection 516, the date selection 518, a recurring date selection 520, a description section 522, and a disposition section 524.

The user 9 can select the residence for which the user 9 wants to add or edit a repair project by using the select residence section 504 drop-down feature. Thereafter, the user 9 can select a current project to edit or select a new project using the type selection 512 feature. For example, the project type may be to add a project to treat the lawn with weed killer and fertilizer, or it could be to edit the yearly furnace service project indicating that it has been performed. The repair type 514 allows the user 9 to select or edit the type of repair, such as but not limited to, service, replacement, renovation, etc. The extent type allows the user 9 to select or edit the category of the repair as a minor or major repair and if the repair is on the home, garage, property, etc. The date allows the user 9 to select or edit a date for which the repair should be completed. The recurring date allows the user 9 to select or edit if the repair should recur a set time period from the date or if the repair is a one time action. The description section 522 allows the user to enter or edit a description that, in some embodiments, can be used by the home maintenance recommendation tool 100 to help suggest products for the repair. The disposition selection allows the user 9 to select or edit if the repair has not been started, is in process, has been completed, etc. The save button 526 allows the user 9 to save any new or edited repair projects.

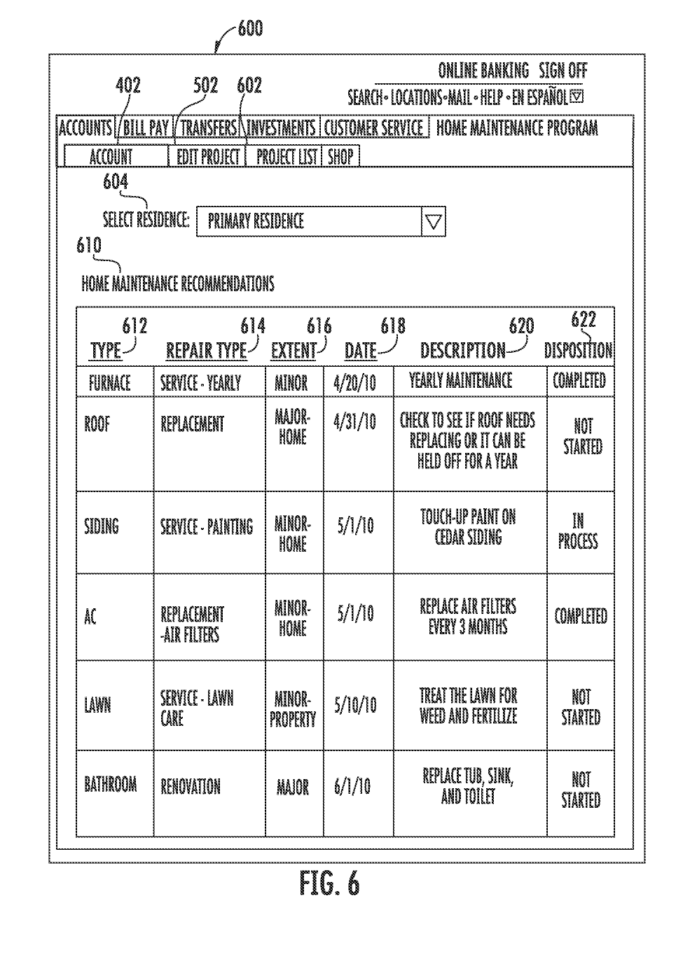

As illustrated by block 216, if the user 9 adds or updates the maintenance projects, the home maintenance recommendation tool 100 updates the home maintenance recommendation project list interface 600 to reflect the changes. As illustrated by block 218, when the user 9 has no more maintenance information to add or update, the home maintenance recommendation tool 100 notifies the user 9 of the next maintenance project deadline. For example, the next deadline may be to apply weed killer to the yard, purchase mulch or pine straw for the yard, aerate the yard, and treat the house for insects. In one embodiment of the invention the home maintenance recommendation tool 100 displays the user 9 the home maintenance project list interface 600 in the project tab 602, as illustrated by FIG. 6. In some embodiments of the invention, the home maintenance project list interface 600 has a select residence section 604 and a home maintenance recommendation section 610. As illustrated in FIG. 6, in some embodiments, the home maintenance recommendation section 610 includes the type 612, the repair type 614, the extent 616, the description 620, and the disposition 622 of the maintenance repair project, as were explained with respect to FIG. 5.

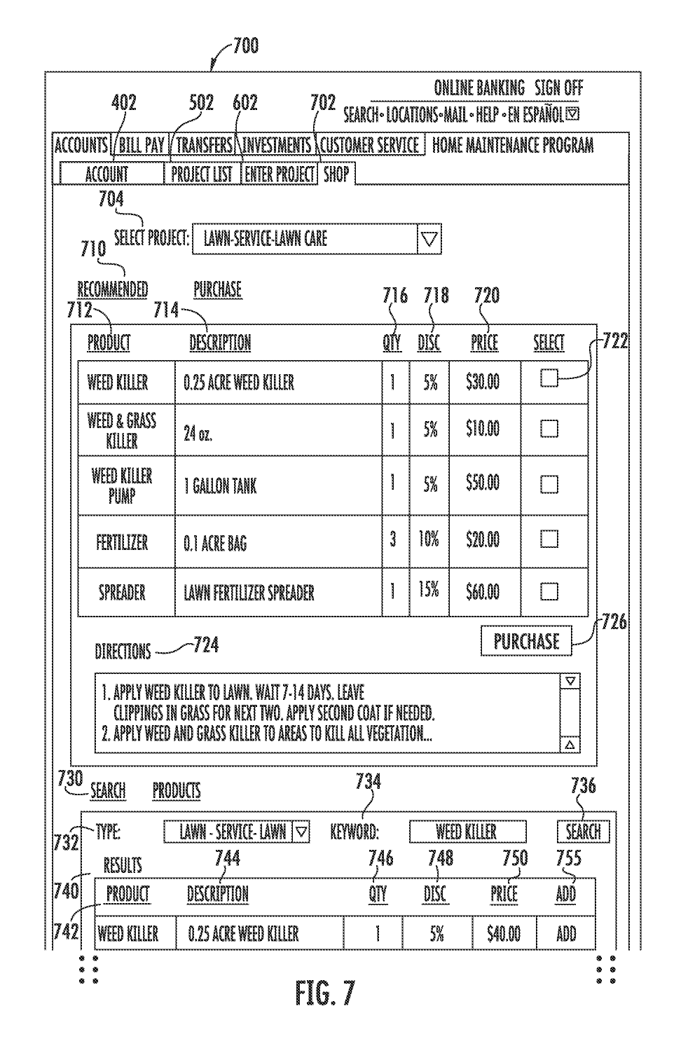

As illustrated by block 220, the home maintenance recommendation tool 100 can receive input to view a maintenance project in the home maintenance recommendation section 610. In some embodiments, the user 9 can view the maintenance project by selecting a link for the maintenance project in the type 612 column. After the input to view a maintenance project is received, the home maintenance recommendation tool 100 displays to the user 9 the home maintenance recommended purchases interface 700 in the shop tab 702, as illustrated in FIG. 7. The home maintenance recommendation purchases interface 700, as explained below, lists the products that it recommends the user 9 purchase in order to complete the home maintenance repair project.

In some embodiments, the home maintenance recommended purchases interface 700 comprises a select project section 704, a recommended purchases section 710, and a search purchases section 730. In some embodiments of the invention, the user 9 can select a particular project in the select project section 704 that the user 9 wants to view. For example, if the home maintenance repair project relates to servicing the furnace, the bank can provide a list of businesses and the associated prices for servicing furnaces. In other embodiments, the home maintenance repair relates to a project entered by the user 9, such as a bathroom renovation. In this case the home maintenance purchases section 710 can display tools and materials needed to make the renovation to the bathroom. In other embodiments, the home maintenance repair relates to a project identified by the home maintenance recommendation tool 100, such as treating the granite in a house, since the home maintenance recommendation tool 100 knows that the house has granite and it hasn't been treated in the last year. In this case, the home maintenance application 100 displays to the user 9 a list of items that can be purchased for treating granite.

For the example illustrated in FIG. 7, the user has selected the lawn project related to lawn care service. As illustrated by the recommended purchases section 710, the home maintenance recommendation tool 100, alone or in connection with partners, determines what products should be recommended to the user 9 based on the maintenance project the user 9 has in the list. In some embodiments of the invention, the recommended products are based at least in part on the mortgage metrics captured, as well as the user's purchasing information. In other embodiments of the invention, the recommended products are based at least in part on the information and/or metrics entered by the user 9 into the home maintenance recommendation tool 100. The home maintenance recommendation tool 100 in some embodiments displays the type of product 712, a description 714 of the product, the quantity 716 recommended, an applicable discount 718, the price of the product 720, and a selection button 722, to add the product to the list of products the user 9 wants to purchase. For example, as illustrated in the recommended purchases section 710 for the lawn care project, the home maintenance recommendation tool 100 recommends that the user purchase weed killer and fertilizer and can provide the amount of weed killer and grass fertilizer needed based on the acrage of the yard captured by the mortgage application 27 or entered by the user 6. For example, in order to cover a one-quarter acre piece of property, the home maintenance recommendation tool 100 recommends a quantity of one (1), at a five (5) percent discount, for a price of thirty (30) dollars. In addition, the home maintenance recommendation tool 100 can also list businesses that will take care of the yard and provide estimates of prices that the businesses charge. The recommended purchases section 710 also includes recommendations to purchase products to apply the weed killer and fertilizer, such as a weed killer pump to apply the weed killer and a spreader to apply the fertilizer. In some embodiments of the invention, the home maintenance tool 100 also provides directions on how to make the repair, as illustrated by the directions section 724, in the recommended purchases section 710.

In other embodiments of the invention, the user 9 can search for specific products in which the user 9 might be interested using the search purchases section 730. In some embodiments of the invention, the search purchases section 730 comprises a type section 732, a keyword section 734, a submit button 736, and a results section 740. The results section can include in some embodiments, the same or similar information as listed in the recommended purchases section 710, such as but not limited to a product column 742, a description column 744, a quantity column 746, a discount column 748, a price column 750, and add feature buttons 752. In one embodiment, the user 9 can select a type of maintenance product in the type section 732, enter keywords into the keyword section 734, and search for related products by selecting the search button 736. The results of the user's search are displayed in the results section 740. If the user identifies a product that the user 9 needs for the maintenance project the user 9 can add the product to the recommended purchases section 710 by selecting the add button 752 next to the product in the results section 740. In this way the user 9 can add or remove products suggested by the home maintenance recommendation tool 100 that the user 9 might prefer to use and/or are cheaper than the recommended products, etc.

The bank maintains strategic relationships with businesses that provide products related to home repair and upkeep. For example, the bank may have strategic partnerships with national, regional, and/or local home maintenance supply stores and/or construction, home repair, home upkeep service providers. Due to the ability of the bank to reach many customers, the businesses in the strategic partnerships with the bank may offer products at discounted prices to bank customers and/or home maintenance tool 100 users. As illustrated by decision block 222, the user 9 may decide whether or not to purchase products through the home maintenance recommendation tool 100 by checking the select buttons 722 and then selecting the purchase button 726. As illustrated by termination block 234, if the user 9 does not want to purchase products through the home maintenance recommendation tool 100 the process may terminate. However, if the user 9 does want to purchase products, the home maintenance recommendation tool 100 may display the list of the products the user 9 selected, as illustrated by block 224.

As illustrated by decision block 226, the user 9 can purchase the products online or print out the list to take to a store to purchase. As illustrated by block 232, if the user 9 decides to print the list to take to a local store, then the process may end. However, as illustrated by block 226, if the user decides to purchase online, then the bank will authenticate the user's purchase information. As illustrated by decision block 228, the user 9 also can have the products shipped to the user's home, which may end the process as illustrated by termination block 234. However, in other embodiments, as illustrated in block 232, the user 9 can purchase the items and go to the store to pick them up where they will already be set aside for the user 9. The user 9 simply needs to display the receipt of the purchase made online at the store location to receive the purchase.

In still other embodiments of the invention, the home maintenance recommendation tool 100 can provide checklists or other directions for performing maintenance actions on the property of the user 9. In other embodiments of the invention, the user 9 may be able to search out specific maintenance repair instructions through the online banking application 17 and purchase the necessary products from strategic partners of the bank through the online banking application 17 as well.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

1. A home maintenance recommendation system, comprising:
a memory device;
a communication device; and
a processing device operatively coupled to the memory device and the communication device, wherein the processing device is configured to execute computer-readable program code to:
receive an authentication request to access a home maintenance recommendation application through an online banking application supported by a financial institution;
receive home maintenance metrics for a property in part from data accessed by the financial institution;
determine a maintenance action that a user should perform on the property, based at least in part on the home maintenance metrics; and
display a maintenance action list reporting the maintenance action that the user should perform on the property in a home maintenance interface.

2. The home maintenance recommendation system of claim 1, wherein the home maintenance metrics received are received from a mortgage origination, a mortgage purchase, or a mortgage refinance supported by the financial institution.

3. The home maintenance recommendation system of claim 1, wherein the home maintenance metrics received are received from a purchase the user made.

4. The home maintenance recommendation system of claim 1, wherein the processing device is further configured to:
receive mortgage information for the property for setting up a mortgage account in the online banking application that allows the user to access the home maintenance interface.

5. The home maintenance recommendation system of claim 1, wherein the processing device is further configured to:
generate a product list of one or more products for the maintenance action; and
display the product list of one or more products for the maintenance action to the user.

6. The home maintenance recommendation system of claim 1, wherein the processing device is further configured to:
prompt the user to purchase one or more products for the maintenance action.

7. The home maintenance recommendation system of claim 6, wherein the processing device is further configured to:
prompt the user to have the one or more products for the maintenance action shipped.

8. The home maintenance recommendation system of claim 6, wherein the processing device is further configured to:
prompt the user to pick-up the one or more products for the maintenance action from a store location.

9. The home maintenance recommendation system of claim 1, wherein the processing device is further configured to:
prompt the user to view a product list of one or more products for the maintenance action to purchase at a store location.

10. (canceled)

11. The home maintenance recommendation system of claim 1, wherein the processing device is further configured to:
receive information related to one or more maintenance actions that the user wants to add to the maintenance action list.

12. The home maintenance recommendation system of claim 1, wherein the processing device is further configured to:
receive information related to one or more products that the user wants to add to the maintenance action.

13. The home maintenance recommendation system of claim 1, wherein the processing device is further configured to:
receive information related to a disposition that the user assigns to the maintenance action.

14. The home maintenance recommendation system of claim 4, wherein the mortgage information comprises an amount of the mortgage, a mortgage payment schedule, or a mortgage account number.

15. The home maintenance recommendation system of claim 1, wherein the home maintenance metrics comprise a home address, size of home, acreage of land, number of rooms, number of bathrooms, flooring type, age of home, date of any major work done on home, the roof type, roof age, furnace type, furnace age, water heater type, water heater age, air conditioner type, air conditioner age, dishwasher type, dishwasher age, fridge types, fridge age, stove type, stove age, siding type, siding age, sewer system type, or sewer system age.

16. A home maintenance recommendation method comprising:
receiving an authentication request to access a home maintenance recommendation application through an online banking application supported by a financial institution;
receiving home maintenance metrics for a property in part from data accessed by the financial institution;
determining, through the use of a processor, a maintenance action that the user should perform on the property, based at least in part on the home maintenance metrics; and
displaying a maintenance action list reporting the maintenance action that the user should perform on the property in a home maintenance interface.

17. The home maintenance recommendation method of claim 16, wherein receiving home maintenance metrics comprises receiving home maintenance metrics from a mortgage origination, a mortgage purchase, or a mortgage refinance supported by the financial institution.

18. The home maintenance recommendation method of claim 16, wherein receiving home maintenance metrics comprises receiving home maintenance metrics from a purchase the user made.

19. The home maintenance recommendation method of claim 16, further comprising:
receiving mortgage information for the property for setting up a mortgage account in the online banking application that allows the user to access the home maintenance interface.

20. The home maintenance recommendation method claim 16, further comprising:
generating, through the use of the processor, a product list of one or more products for the maintenance action; and
displaying the product list of one or more products for the maintenance action to the user.

21. The home maintenance recommendation method of claim 16, further comprising:
prompting, through the use of the processor, the user to purchase one or more of the products for the maintenance action.

22. The home maintenance recommendation method of claim 21, further comprising:
prompting, through the use of the processor, the user to have the one or more products for the maintenance action shipped.

23. The home maintenance recommendation method of claim 21, further comprising:
prompting, through the use of the processor, the user to pick-up the one or more products for the maintenance action from a store location.

24. The home maintenance recommendation method of claim 16, further comprising:
prompting, through the use of the processor, the user to view a product list of one or more products for the maintenance action to purchase at a store location.

25. (canceled)

26. The home maintenance recommendation method of claim 16, further comprising:
receiving, through the use of the processor, information related to one or more maintenance actions that the user wants to add to the maintenance action list.

27. The home maintenance recommendation method of claim 16, further comprising:
receiving, through the use of the processor, information related to adding one or more products that the user wants to add to the maintenance action.

28. The home maintenance recommendation method of claim 16, further comprising:
receiving, through the use of the processor, information related to a disposition that the user assigns to the maintenance action.

29. The home maintenance recommendation method of claim 19, wherein the mortgage information comprises an amount of the mortgage, a mortgage payment schedule, or a mortgage account number.

30. The home maintenance recommendation method of claim 16, wherein the home maintenance metrics comprise a home address, size of home, acreage of land, number of rooms, number of bathrooms, flooring type, age of home, date of any major work done on home, the roof type, roof age, furnace type, furnace age, water heater type, water heater age, air conditioner type, air conditioner age, dishwasher type, dishwasher age, fridge types, fridge age, stove type, stove age, siding type, siding age, sewer system type, or sewer system age.

31. A computer program product for a home maintenance recommendation system, the computer program product comprising at least one non-transitory computer-readable medium having computer-readable program code portions embodied therein, the computer-readable program code portions comprising:
an executable portion configured for receiving an authentication request to access a home maintenance recommendation application through an online banking application supported by a financial institution;
an executable portion configured for receiving home maintenance metrics for a property in part from data accessed by the financial institution;
an executable portion configured for determining a maintenance action that the user should perform on the property, based at least in part on the home maintenance metrics; and
an executable portion configured for displaying a maintenance action list reporting the maintenance action that the user should perform on the property in a home maintenance interface.

32. The computer program product of claim 31, wherein the executable portion configured for receiving home maintenance metrics comprises an executable portion configured for receiving home maintenance metrics from a mortgage origination, a mortgage purchase, or a mortgage refinance supported by the financial institution.

33. The computer program product of claim 31, wherein the executable portion configured for receiving home maintenance metrics comprises an executable portion configured for receiving home maintenance metrics from a purchase the user made.

34. The computer program product of claim 31, further comprising:
an excludable portion configured for receiving mortgage information for the property for setting up a mortgage account in the online banking application that allows the user to access the home maintenance interface.

35. The computer program product of claim 31, further comprising:
an executable portion configured for generating a product list of one or more products for the maintenance action; and
an executable portion configured for displaying the product list of one or more products for the maintenance action to the user.

36. The computer program product of claim 31, further comprising:
an executable portion configured for prompting the user to purchase one or more of the products for the maintenance action.

37. The computer program product of claim 36, further comprising:
an executable portion configured for prompting the user to have the one or more products for the maintenance action shipped.

38. The computer program product of claim 36, further comprising:
an executable portion configured for prompting the user to pick-up the one or more products for the maintenance action from a store location.

39. The computer program product of claim 31, further comprising:
an executable portion configured for prompting the user to view a product list of one or more products for the maintenance action to purchase at store location.

40. (canceled)

41. The computer program product of claim 31, further comprising:
an executable portion configured for receiving information related to one or more maintenance actions that the user wants to add to the maintenance action list.

42. The computer program product of claim 31, further comprising:
an executable portion configured for receiving information related to adding one or more products that the user wants to add to the maintenance action.

43. The computer program product of claim 31, further comprising:
an executable portion configured for receiving information related to a disposition that the user assigns to the maintenance action.

44. The computer program product of claim 34, wherein the mortgage information comprises an amount of the mortgage, a mortgage payment schedule, or a mortgage account number.

45. The computer program product of claim 31, wherein the home maintenance metrics comprise a home address, size of home, acreage of land, number of rooms, number of bathrooms, flooring type, age of home, date of any major work done on home, the roof type, roof age, furnace type, furnace age, water heater type, water heater age, air conditioner type, air conditioner age, dishwasher type, dishwasher age, fridge types, fridge age, stove type, stove age, siding type, siding age, sewer system type, or sewer system age.

46. An online banking home maintenance recommendation system, comprising:
a memory device;
a communication device; and
a processing device operatively coupled to the memory device and the communication device, wherein the processing device is configured to execute computer-readable program code to:
receive an authentication request to access a home maintenance recommendation application through an online banking application supported by a financial institution;
receive home maintenance metrics for a property in the online banking application in part from data accessed by the financial institution;
determine a maintenance action that a user should perform on the property, based at least in part on the home maintenance metrics; and
display a maintenance action list reporting the maintenance action that the user should perform on the property in a home maintenance interface in the online banking application.

47. The home maintenance recommendation system of claim 46, wherein the home maintenance metrics received are received from a mortgage origination, a mortgage purchase, a mortgage refinance, or from a from a purchase the user made supported by the financial institution.

48. An online banking home maintenance recommendation method comprising:
receiving an authentication request to access a home maintenance recommendation application through an online banking application supported by a financial institution;
receiving home maintenance metrics for a property in the online banking application in part from data accessed by the financial institution;
determining, through the use of a processor, a maintenance action that the user should perform on the property, based at least in part on the home maintenance metrics; and
displaying a maintenance action list reporting the maintenance action that the user should perform on the property in a home maintenance interface in the online banking application.

49. The home maintenance recommendation method of claim 48, wherein receiving home maintenance metrics comprises receiving home maintenance metrics from a mortgage origination, a mortgage purchase, a mortgage refinance, or from a purchase the user made supported by the financial institution.
